(19) United States
(12) Patent Application Publication
(10) Pub. No.: US 2026/0104882 A1
(43) Pub. Date: Apr. 16, 2026

(54) MINIMAL IMPACT SOFTWARE UPDATE DEPLOYMENT

(71) Applicant: Robert Bosch GmbH, Stuttgart (DE)

(72) Inventors: SEKAR KULANDAIVEL, Pittsburgh, PA (US); JORGE GUAJARDO MERCHAN, Pittsburgh, PA (US); STEFAN GEHRER, Pittsburgh, PA (US)

(21) Appl. No.: 18/916,247

(22) Filed: Oct. 15, 2024

(51) Int. Cl. G06F 8/65

(52) U.S. Cl. CPC G06F 8/65

(57) ABSTRACT

A software update to update existing portions of a software application is received, the software update indicating a placeholder instruction update to a placeholder instruction of the software application and a placeholder code area update to a placeholder code area of the software application. The placeholder code area update is applied to the placeholder code area, the placeholder code area being a pre-allocated portion of a code segment of a software application outside of the code path that is reserved at compile time for future use. The placeholder instruction update is applied to the placeholder instruction, the placeholder instruction being an instruction in the code path that is predefined in the software application as built, to be modified and/or replaced with another instructions to call a section of code that is outside of the code path. The software application as modified is executed, to apply the software update.

### TECHNICAL FIELD

Aspects of the disclosure generally relate to deployment of software updates with minimal impact on original code sections of the software application.

### BACKGROUND

Software diversity is a security and performance enhancement technique that leverages the modularity of computing software by using various implementations, or variations, of software modules. By utilizing different versions of a module that perform the same functionality but have different code structures, software diversity reduces the likelihood that a vulnerability in one module variation will compromise the entire system. This inconsistency in module implementations across different devices makes it more difficult for malware to exploit the same vulnerability widely, thereby increasing the overall security and robustness of the software ecosystem.

Frameworks may be used for performing delta updates, where the update itself contains just the delta (i.e., parts of the code that are different) of the new code versus the old code. This approach saves on over-the-air (OTA) resources, time, and computing constraints.

### SUMMARY

In one or more illustrative examples, a method for deploying a software update to an electronic control unit (ECU) includes receiving a software update to update existing portions of a software application, the software update indicating a placeholder instruction update to a placeholder instruction of the software application and a placeholder code area update to a placeholder code area of the software application; applying the placeholder code area update to the placeholder code area, the placeholder code area being a pre-allocated portion of a code segment of a software application outside of the code path that is reserved at compile time for future use; applying the placeholder instruction update to the placeholder instruction, the placeholder instruction being an instruction in the code path that is predefined in the software application as built, to be modified and/or replaced with another instructions to call a section of code that is outside of the code path; and executing the software application as modified, to apply the software update.

In one or more illustrative examples, the placeholder instruction update indicates a location of the placeholder instruction to update and the instructions to replace the placeholder instruction with.

In one or more illustrative examples, the placeholder code area update indicates which placeholder code area to update and the instructions to add to the placeholder code area.

In one or more illustrative examples, the placeholder code area update indicates that the placeholder code area is preloaded with instructions and does not require an update.

In one or more illustrative examples, the placeholder code area update includes a remote procedure call to a remote computing device that to be called as part of the code path as updated.

In one or more illustrative examples, the placeholder instruction includes a delay loop that is replaced by the software update to preserve timing after addition of the placeholder code area update.

In one or more illustrative examples, the timing of the delay loop is randomized across the ECU and other ECUs executing the software application.

In one or more illustrative examples, the software update implements a reduced alternative to update the existing portions of the software application, the reduced alternative eliminating a feature or returning with an error to remove a function of the software application.0

In one or more illustrative examples, the software update implements a stricter alternative to update the existing portions of the software application, the stricter alternative enhancing an existing security check or adding a new security check to increase security of a function of the software application.

In one or more illustrative examples, the software update implements a diverse alternative to update the existing portions of the software application, the diverse alternative including an alternative version of a function of the software application that is functionally equivalent but constructed differently.

In one or more illustrative examples, the placeholder instructions are located at the entry and/or exit points of basic blocks of instructions of the software application, wherein the basic blocks of instructions are connected by edges that are changes in control flow of the instructions.

In one or more illustrative examples, the placeholder instructions are located to produce a pattern unique to the software application for identifying the software application.

In one or more illustrative examples, the placeholder instructions are chosen to include a power consumption pattern unique to the software application for identifying the software application.

In one or more illustrative examples, a system for deploying a software update to an electronic control unit (ECU) includes an ECU having a memory and a processor, wherein ECU is configured to: receive a software update to update existing portions of a software application, the software update indicating a placeholder instruction update to a placeholder instruction of the software application and a placeholder code area update to a placeholder code area of the software application; apply the placeholder code area update to the placeholder code area, the placeholder code area being a pre-allocated portion of a code segment of a software application outside of the code path that is reserved at compile time for future use; apply the placeholder instruction update to the placeholder instruction, the placeholder instruction being an instruction in the code path that is predefined in the software application as built, to be modified and/or replaced with another instructions to call a section of code that is outside of the code path; and execute the software application as modified using the processor, to apply the software update.

In one or more illustrative examples, the placeholder instruction update indicates a location of the placeholder instruction to update and the instructions to replace the placeholder instruction with.

In one or more illustrative examples, the placeholder code area update indicates which placeholder code area to update and the instructions to add to the placeholder code area.

In one or more illustrative examples, the placeholder code area update indicates that the placeholder code area is preloaded with instructions and does not require an update.

In one or more illustrative examples, the placeholder code area update includes a remote procedure call to a remote computing device that to be called as part of the code path as updated.

In one or more illustrative examples, the placeholder instruction includes a delay loop that is replaced by the software update to preserve timing after addition of the placeholder code area update.

In one or more illustrative examples, the timing of the delay loop is randomized across the ECU and other ECUs executing the software application.

In one or more illustrative examples, the software update implements a reduced alternative to update the existing portions of the software application, the reduced alternative eliminating a feature or returning with an error to remove a function of the software application.

In one or more illustrative examples, the software update implements a stricter alternative to update the existing portions of the software application, the stricter alternative enhancing an existing security check or adding a new security check to increase security of a function of the software application.

In one or more illustrative examples, the software update implements a diverse alternative to update the existing portions of the software application, the diverse alternative including an alternative version of a function of the software application that is functionally equivalent but constructed differently.

In one or more illustrative examples, the placeholder instructions are located at the entry and/or exit points of basic blocks of instructions of the software application, wherein the basic blocks of instructions are connected by edges that are changes in control flow of the instructions.

In one or more illustrative examples, the placeholder instructions are located to produce a pattern unique to the software application for identifying the software application.

In one or more illustrative examples, the placeholder instructions are chosen to include a power consumption pattern unique to the software application for identifying the software application.

In one or more illustrative examples, a non-transitory computer-readable medium includes instructions that, when executed by an ECU having a processor and a memory, cause the ECU to perform operations including to: receive a software update to update existing portions of a software application, the software update indicating a placeholder instruction update to a placeholder instruction of the software application and a placeholder code area update to a placeholder code area of the software application; apply the placeholder code area update to the placeholder code area, the placeholder code area being a pre-allocated portion of a code segment of a software application outside of the code path that is reserved at compile time for future use; apply the placeholder instruction update to the placeholder instruction, the placeholder instruction being an instruction in the code path that is predefined in the software application as built, to be modified and/or replaced with another instructions to call a section of code that is outside of the code path; and execute the software application as modified using the processor, to apply the software update.

### BRIEF DESCRIPTION OF THE DRAWINGS

FIG. 1 illustrates an example detail of the components of an electronic control unit (ECU) configured to execute software;

FIG. 2 illustrates an example code segment including a placeholder instruction and a placeholder code area;

FIG. 3 illustrates an example of an update of the placeholder instruction and the placeholder code area to deploy a software update to the software;

FIG. 4 illustrates an example of an update of the placeholder instruction and the placeholder code area to deploy a software update to the software including a remote procedure call;

FIG. 5 illustrates an example software update for one or more of the ECUs; and FIG. 6 illustrates an example process for updating of the placeholder instruction and the placeholder code area to deploy a software update to the software.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Recent standards and policies require long-term support for managing software security vulnerabilities in the automotive industry. As a result, Original Equipment Manufacturers (OEMs) and their suppliers face challenges in designing and building vehicle computers (or electronic control units (ECUs)) that can be updated 15+ years from the end of production date. These updates that get pushed over a decade into the future require significant effort from the Electronic Control Unit (ECU) designer and product security incident response team (PSIRT). Software updates may require safety testing, and the engineering team may have lost the software development environment and original technical staff.

Aspects of the disclosure relate to methods of inserting placeholders into the original software release of a vehicle or other computer. To update the software, the placeholder is modified or replaced with another instruction or instructions that accesses the different section of code on either the same ECU or a different ECU on the vehicle network. This allows for safety or other testing of the fix to be limited to just this allocated section of code, avoid retesting other software components or even the software as a whole.

In contrast to using identifiers to disable an existing version of code, the disclosed approach presents a new technique to perform software updates. Using the disclosed technique, deployment can include not only diverse software but other fixes such as reduced functionality versions and even enhanced security versions of software. Moreover, in contrast to delta updates, the disclosed approach reduces changes to the original code through use of a new memory to implement a software fix. Using the disclosed approach, a software fix can be deployed where only the fix likely needs to be safety tested again as the original code segment remains virtually untouched. Further aspects of the disclosure are discussed in detail herein.

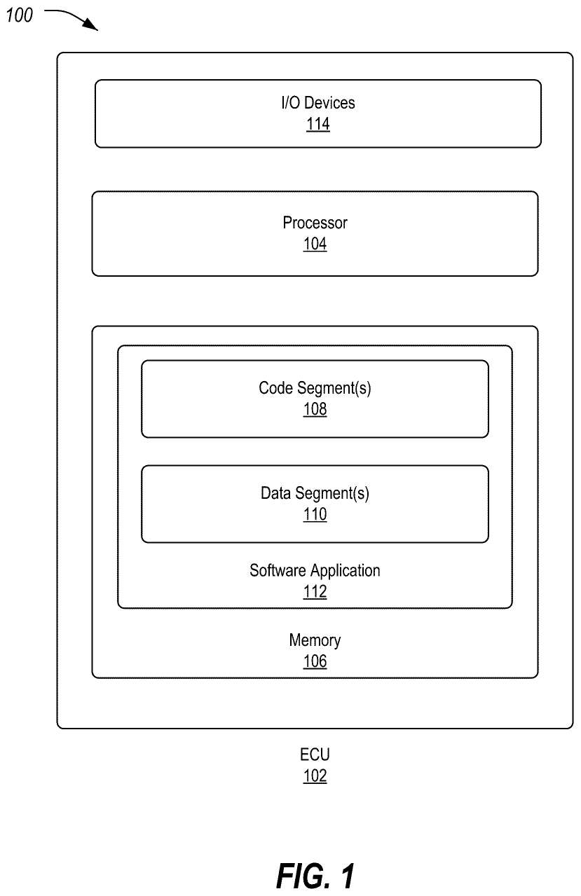

FIG. 1 illustrates an example detail of the components of an ECU 102 configured to execute a software application 112. As shown, the ECU 102 may include a processor 104 and a memory 106. Code segments 108 and data segments 110 of the software application 112 may be stored to the memory 106. The ECU 102 may also include various input/output (I/O) devices 114. It should be noted that this is only an example, and ECUs 102 having more, fewer, or different components or structures may be used.

The processor 104 may be responsible for executing instructions. The processor 104 may fetch instructions from the memory 106, decodes the instructions, executes them, and write back result into the memory 106. The memory 106 may be configured to store the code segments 108 and the data segments 110 that the processor 104 needs to access. The code segments 108 may generally include computer-executable instructions, where the instructions may be executable by the processor 104. The data segments 110 may include information to be operated on by the instructions. Computer-executable instructions may be compiled or interpreted from computer programs created using a variety of programming languages and/or technologies, including, without limitation, and either alone or in combination, Java™, C, C++, C #, Visual Basic, JavaScript, Python, JavaScript, Perl, etc. In general, the processor 104 receives the instructions, e.g., from the memory 106, a computer-readable medium, etc., and executes these instructions, thereby performing one or more processes, including one or more of the processes described herein. Such instructions and data may be stored and transmitted using a variety of computer-readable media.

The I/O devices 114 may include various features that allow the ECU 102 to interact with external components and/or the environment. These may include sensors configured to sense various physical phenomena, transceivers include communications hardware to allow an exchange of information between the ECU 102 and external devices, as well as human machine interface (HMI) devices such as displays, keyboards, and touchscreens to allow a user to interact with the ECU 102.

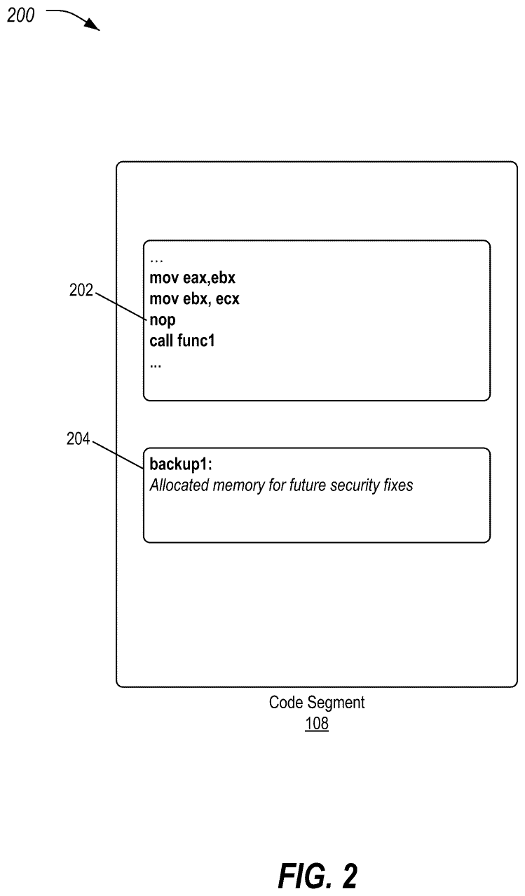

FIG. 2 illustrates an example code segment 108 including a placeholder instruction 202 and a placeholder code area 204. As shown, the example code segment 108 includes a portion of instructions, the placeholder instruction 202, and then further instructions. Also, the code segment 108 includes the placeholder code area 204 which is not presently in the path of execution.

The placeholder instruction 202 refers to one or more instructions in the code path that are predefined in a software build to be modified and/or replaced with other one or more instructions to call a section of code that is not presently being called. The section of code may be resident on either the same ECU 102 or on a different ECU 102 on the network. As shown, the placeholder instruction 202 is a NOP, short for “No Operation,” which is an assembly language instruction that does nothing and simply passes control to the next instruction. Using simple NOP instructions can be sufficient, but the ECU designer may to ensure that the placeholder instruction 202 is not optimized out by the compiler. Moreover, a NOP instruction is easy to identify as a placeholder instruction 202. Thus, other placeholder instructions 202 may be used. The choice of what instruction to use as the placeholder instruction 202 may be up to the ECU designer.

For example, the ECU designer may decide to use a multi-byte NOP or a JMP instruction that points to itself as the placeholder instruction 202. As some further non-limiting examples that may be used alone or in combination, the placeholder instruction(s) 202 may include: moving a register's value to itself (MOV AX, AX), exchanging the value of two registers to itself (XCHG AX, AX), a self-referential operation such as a load effective address to itself (LEA AX, [AX]), a push and pop sequence that leaves a register effectively unchanged, (e.g., PUSH AX, POP AX), an increment decrement sequence that leaves a register effectively unchanged, (e.g., INC AX, DEC AX), applying an operation to a register that doesn't alter the value (e.g., AND AX, AX or OR AX, AX), a compare or test operation that sets flags that are unused by the code flow, or even more complicated appearing logic that has no effect on the function of the software application 112.

This placeholder instruction 202 may be designed to resemble more realistic characteristics of the code segment 108 when performing safety testing. The safety test may analyze timing, register values, etc. so this option may be ideal. The ECU designer could also add a sleep/delay timer (for example, with a maximum delay of a likely or predefined replacement function) at the placeholder location during the verification and validation phase of the software application 112. This approach could ensure that the replacement code would not lead to timing changes or violations.

The placeholder code area 204 refers to a pre-allocated portion of the code segment 108 of a software application 112 that is reserved for future use. The placeholder code area 204 may generally not be included in the code path when the placeholder instruction 202 is unmodified but is included in the code path after the placeholder instruction 202 is modified. It should be noted that in some examples, the placeholder code area 204 includes an allocated without code, while in other examples the placeholder code area 204 may initially include functioning executable code that is simply not turned on.

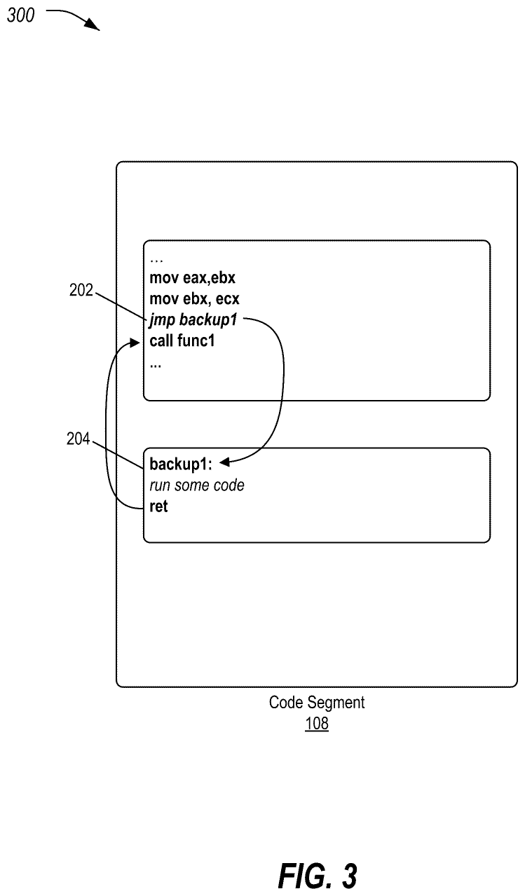

FIG. 3 illustrates an example 300 of an update of the placeholder instruction 202 and the placeholder code area 204 to deploy a software update to the software application 112. As shown, the placeholder instruction 202 is updated from a NOP to a JMP into the placeholder code area 204. Additionally, the placeholder code area 204 is updated to include code which is jumped to and that returns back to after the placeholder instruction 202. Because the memory 106 for the placeholder code area 204 is pre-allocated in the original binary, the scope of the testing that needs to be performed to make the change is more limited in scope as compared to a new build with other portions of the code having been moved or otherwise changed.

An example of the deployment steps to perform this update may be as follows. A need to deploy a vulnerability fix to the ECU 102 is determined. The fix is designed, tested, and implemented (a satisfactory alternative that was prebuilt is identified). A software update is initiated to the ECU 102, where the update includes two modifications. These include replacement of the appropriate placeholder instruction 202 (e.g., blank NOP or blank JMP) with a jump instruction to the allocated placeholder code area 204 in the memory 106 designed to store the vulnerability fix. These also include the code for the vulnerability fix written into the allocated memory 106 (e.g., if a prebuild alternative is not identified). Once these changes are made, the ECU 102 may be restarted and the software update may run.

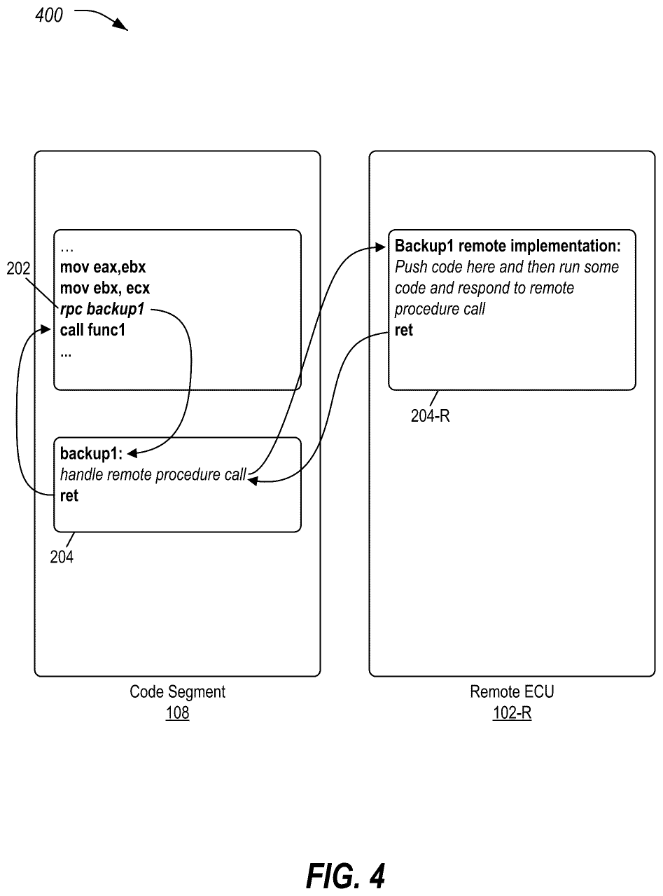

FIG. 4 illustrates an example 400 of an update of the placeholder instruction 202 and the placeholder code area 204 to perform a remote procedure call to implement a software update. As compared to the example 300, in the example 400 the placeholder instruction 202 is again updated to jump to the placeholder code area 204. However, in this case the placeholder code area 204 is updated to handle a remote procedure call to another ECU 102-R (e.g., the “remote” ECU 102). The remote procedure call is configured to execute code in a placeholder code area 204-R of the remote ECU 102-R. The remote procedure call then returns back to the placeholder code area 204 of the ECU 102, which in turn then returns back to the remainder of the code of the code segment 108.

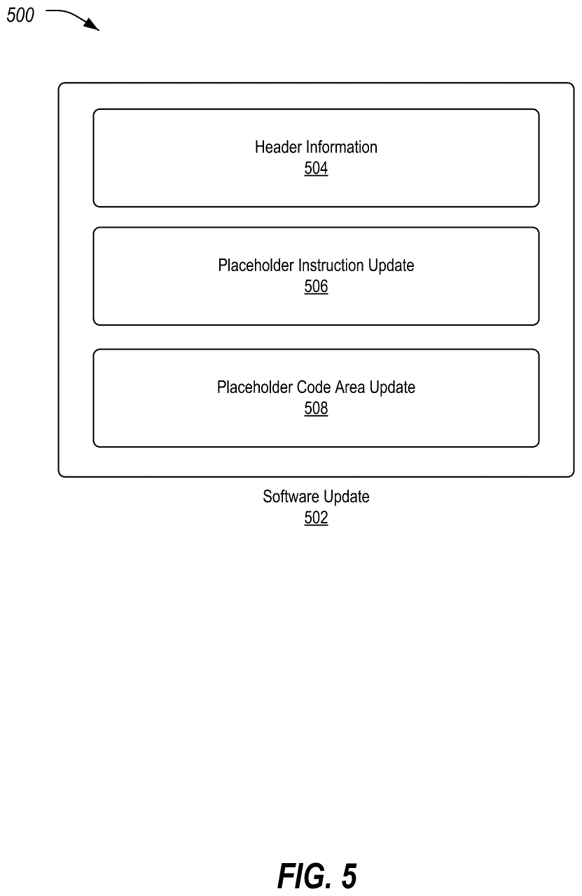

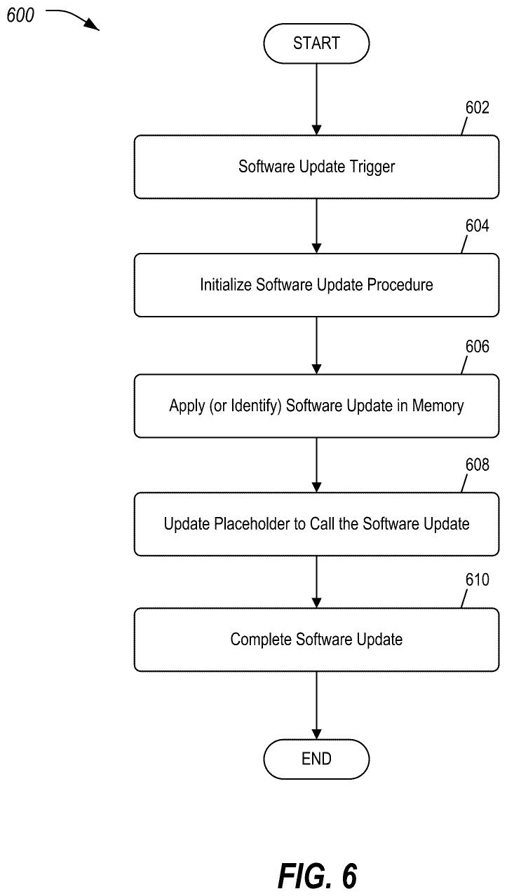

FIG. 5 illustrates an example software update 502 for one or more of the ECUs 102. As shown, the software update 502 may include header information 504, a placeholder instruction update 506, and a placeholder code area update 508. It should be noted that this is only an example, and software updates 502 having more, fewer, or different fields or structures may be used.

The header information 504 may include information indicative of the ECU 102 to be updated. This may indicate, as an example, a name or unique identifier of the ECU 102. This may also indicate, for instance, a version number of the software application 112 of the ECU 102 to be updated. The header information 504 may be used to ensure that the software update 502 corresponds to the current ECU 102 of the current version to receive the changes.

The placeholder instruction update 506 may include an indication of which placeholder instruction 202 to update. In a simple example, the placeholder instruction update 506 may reference the placeholder instruction 202 by location offset into the code segment 108 to be updated. In another example, each of the placeholder instruction 202 locations may be numbered in a lookup table, and the placeholder instruction update 506 may indicate the number of the placeholder instruction 202 where the address is then retrieved from the lookup.

The placeholder instruction update 506 may also indicate the new instructions to be applied to the placeholder instruction 202. This may be as simple as including the instructions to replace the placeholder instruction 202 with. Or, in another example, the placeholder instruction update 506 may indicate which placeholder code area update 508 to jump to, and the ECU 102 may construct the appropriate jump instruction to put in place of the existing placeholder instruction 202.

The placeholder code area update 508 may include the code of the fix to be applied to the placeholder code area 204. In an example, this may include the instructions to be applied to the placeholder code area 204. In another example, if the potential fix was preloaded into the placeholder code area 204, then the placeholder code area update 508 may indicate that no specific change to the placeholder code area 204 is required.

An example of the deployment steps to apply the software update 502 may be as follows. A need to deploy a vulnerability fix to the ECU 102 is determined. The fix is designed, tested, and implemented (a satisfactory alternative that was prebuilt is identified). A software update 502 is initiated to the ECU 102, where the software update 502 includes three modifications. These include replacement of the appropriate placeholder instruction 202 (e.g., blank NOP or blank JMP) with a jump instruction to the allocated placeholder code area 204 memory 106, which is updated to include an implementation to perform the remote procedure call to the other ECU 102-R. Additionally, code implementing the vulnerability fix is created and updated into the memory 106 of the other ECU 102-R. Once these changes are made, the ECU 102 and the ECU 102-R may be restarted and the software update 502 may run.

The ECU designer may identify where to insert the placeholder instructions 202. As inserting placeholder instructions 202 can increase the size of the release code, the designer must take care to limit the number of placeholder instructions 202. Some ideal positions might include before and after security functions, before and after critical functions, before and after open-source functions, before and after third-party functions, etc. With respect to the added code size, a placeholder instruction 202 inserted every 10 lines has a 10% overhead to the code, every 20 lines has a 5% overhead to the code, and so on.

Another approach to identify potential locations for inserting the placeholder instructions 202 is to look at certain properties of the code and insert more placeholder instructions 202 where security rigor is lower. Some properties to distinguish sections of code include application versus firmware code (where firmware typically has more rigor and testing), low-level and less frequently updated code typically has more rigor (such as drivers and other basic functionality code), etc. The number and type of disclosed vulnerabilities (such as common vulnerabilities and exposures (CVEs)) could also indicate which sections of code should have more placeholder instructions 202. Code that has static analysis and other security rigor could likely have a reduced number of placeholder instructions 202. A potential function to consider for the number of placeholder instructions 202 may be a function of the code's update history, the code's creator, and the past CVEs for that code.

Several alternatives may be used for designing the software update 502 that may be deployed to an ECU 102 with the placeholder instructions 202 in its software application 112. These alternatives for the software update 502 may include reduced alternative fixes, stricter alternative fixes, diverse alternative fixes, and/or enhanced alternative fixes. The disclosed approach of using placeholder instructions 202 makes these various types of fixes advantageous as security fixes can be deployed inline with existing code with strategically placed placeholder instructions 202, which are explained herein. Using this approach, the ECU designer can reduce the risk of the overall software application 112 by predicting where likely vulnerabilities could occur and then selecting the appropriate alternative below to mitigate a potential vulnerability.

In a reduced alternative, the software update 502 could simply reduce the functionality of a given block. Some vulnerabilities require a specific feature to be implemented (and then exploited). By eliminating this feature or returning with an error when the specific function is called, a software update 502 could mitigate such a vulnerability. Many automotive software application 112 vendors offer multiple configuration options when generating code for a given project. One approach to implementing this reduced functionality is using a placeholder instruction 202 inserted just before the return of the called function (involved in the vulnerability) to overwrite the return value with an error return value or a “not-supported” return value, which are return values already offered in the configuration. In this case, a feature is effectively removed, and further exploitation of that feature is blocked.

In a stricter alternative, the software update 502 to mitigate a vulnerability may include enhancing an existing security check, such as a counter that tracks the number of attempts or an input sanitizer that strips out potential code injection attacks. One possible stricter alternative to insert at the placeholder instruction 202 location is a different expiration time. In case an expiration time is too long in practice due to a new vulnerability (e.g., diagnostic authentication attack functions in just three attempts instead of ten), the system designer could use this method to implement a smaller expiration time. Another possible stricter alternative to insert includes the use of a different maximum count of login attempts. As with the expiration times, the system designer could prepare another version that reduces the maximum count of login attempts. Another possible stricter alternative includes the use of different error handling. In case an error handling mechanism can be exploited by an attacker (e.g., exploiting a null pointer reference error handling mechanism), the system designer can prepare another version of the error handling response code. Yet another possible stricter alternative includes the use of different input sanitization methods. In case an input sanitization method is not strict enough (e.g., an attack can exploit an edge case to launch a remote code execution attack), the system designer can prepare another input sanitization function.

This approach is advantageous for this type of software update 502 when a placeholder instruction 202 is inserted after existing security checks and within error-handling code blocks. For example, a stricter alternative deployed after an existing security check can perform further sanitization of a particular input (e.g., scrapping semicolons from an input, removing keywords, or even intentionally throwing an error if malicious input is detected). Likewise, within an error-handling block, an example software update 502 could perform additional checks to system state to determine if an error was malicious or not.

In a diverse alternative, the software update 502 to mitigate a vulnerability may include designing different versions of the software application 112 that are functionally equivalent but constructed differently. This may be done to avoid a common weakness, as a solution for mitigating vulnerabilities that exploit a weakness in a block of the construction of the software application 112. Commonly known as software diversity, this approach may be implemented if the different versions are built by independent developers who do not share a programming process. However, a single ECU designer could design multiple versions of the software application 112 using guidance on which functions within that software application 112 are likely to have a currently undiscovered vulnerability. The intent here is to design one or more alternative versions that could be deployed into an existing placeholder instruction 202 and/or selected by updating a placeholder instruction 202 to point to an alternative that was shipped in the existing code but not used.

A non-exhaustive list of approaches for constructing different versions of the software application 112 may include one or more of the following. For instance, different source of randomness may be used, such that case one source is compromised (e.g., controllable by an attacker), the ECU designer could switch to a different source that is not vulnerable. In another example, different cryptographic algorithms could be used, such that in case one type of algorithm is compromised (e.g., algorithm is broken, or the library implemented around the algorithm is broken), the ECU designer could switch to a different algorithm that is not broken. The difference between two algorithms can range from the whole algorithm to a different key size and even changing the initialization vector.

In yet another example, different factors for multi-factor authentication (MFA) may be used, such that in case one factor in an MFA implementation is compromised (e.g., text message codes controllable by attacker), the ECU designer could activate a different factor and require the user to use that factor instead. In still another example, different storage mechanism for credentials may be used, such that in case a storage mechanism for credentials is compromised (e.g., cryptographic hash function is broken), the ECU designer could prepare another mechanism type to activate. In another possibility, different ports may be used such that in case an attack is enabled because a specific port is left open (e.g., cellular port for diagnostic is left open), the ECU designer can prepare another version that uses a different port that does not have the same attack path.

In these examples, the deployed software update 502 would likely replace a block of code to implement a diverse version of that same block. Where the diverse alternative described here could be designed once a vulnerability is identified, the disclosed approach may also be advantageous for designing diverse versions ahead of time (even prior to the ECU's production). By identifying where a placeholder will exist in the ECU's software application 112, an ECU designer can then design and store alternative versions to replace blocks of the software application 112 ahead of time. For example, a future product security incident response team (PSIRT) may access a database of already built and tested software updates 502 stored in a database. If a future identified vulnerability could be mitigated by a software update 502 in this database of diverse alternatives, the PSIRT could push a solution faster without any need for testing.

In addition to the diverse constructs noted above, an ECU designer could use additional techniques to prepare diverse versions ahead of time. For example, different design/coding teams may be used. The ECU designer could contract (at least partly) independent teams to implement the same specifications with the hope that they are unlikely to make the same “mistakes. ” Some ways to enforce this include requiring the use of different open-source libraries, different software architectures, etc.

In another example, different coding standards and/or programming languages may be used. The ECU designer could require different teams to build a software update 502 in different languages with the intent to avoid vulnerabilities that are only present in certain languages. For example, an input sanitization function may produce a different output based on the programming language. The different implementations could be obtained by programming in different languages (one can be of a software application 112 function using a high-level language (C/C++, Java, Rust, etc.) or low-level such as assembly). If a particular final language needs to be supported, then a cross-compiler or trans-compiler can be used to translate the first different language to the final desired language.

In still another example, different compilers may be used. The ECU designer could use different compilers to avoid compiler-induced vulnerabilities. For example, a compiler's optimization of a function could remove a boundary condition check where another compiler's optimization would not.

In one or more other examples, a compiler may generate a control-flow graph (CFG), includes basic blocks of instructions and edges that are changes in control flow via jump instructions or similar. For some or all of the basic blocks in the CFG, placeholder instructions may be added (such as NOPs (no JUMP instructions, though)) or other instructions that do not modify registers, etc. The placeholder instructions may be added to all of the basic blocks in the CFG or only to some, which have been chosen because they are particularly relevant to some critical functionality. Critical functionality could mean that the basic block implements security functionality (encryptions, signing, hashing, authentication, etc.) or safety critical functionality, as typical examples. From the CFG augmented with the modified basic blocks, the final code is regenerated. This process may be combined with any of the other approaches discussed herein (such as using multiple developer teams or different code languages, etc.). For example, the compiler may generate basic blocks of instructions and edges that are changes in control flow of the instructions, and locate the placeholder instructions at the entry and/or exit points of the basic blocks.

In some examples, a second version of the software application 112 is sufficient. However, for sake of completeness, the number of diverse alternatives could be extended to three, four, and as many as N versions of the software application 112. The implementation of more than two versions may be up to the ECU designer as a trade-off must be made between the benefit of multiple versions and the cost to implement those versions. Some examples of a necessary trade-off are for software functions that are mission-critical functions or safety-critical functions.

FIG. 6 illustrates an example process 600 for updating of the placeholder instruction 202 and the placeholder code area 204 to deploy a software update 502. In an example, the process 600 may be applied to one or more of the ECUs 102 discussed in detail herein.

At operation 602, application of a software update 502 is triggered. In an example, the trigger may be a manual interaction. However, in other examples, the trigger may be an automated trigger. In one example of an automated trigger, an intrusion detection and prevention system (IDPS) may be monitoring network and system activities of the ECU 102 for malicious activities or policy violations and take action to in view of an identified threats. In another example, an internal mechanism of the vehicle or other device including the ECUs 102 triggers activation of a software update 502 (e.g., an enhanced alternative) for a particular section of code, e.g., by providing a software update 502 to the ECUs 102 to be updated.

It should be noted that a trigger approach may include combinations of techniques and it not necessary to choose just one approach. In some examples, a deployment strategy may elect multiple techniques. For example, a deployment strategy could split decisions for a novel vulnerability detection into major and minor decisions. For major decisions that require approval from leadership and risk analysis by the PSIRT, those software updates 502 could be deployed on command instead of automatically. For minor decisions or even safety-relevant decisions that need to be implemented in real-time scales, these deployments may occur without obtaining approval from a human. Such an automatic deployment assumes that there is enough information gathered on the vehicle or other device including the ECUs 102 to make this decision, and this decision-making process should be safety tested as well. The software update 502 here would need to be planned and tested before loading them somewhere on the vehicle's software application 112. This automated approach would be valuable on an autonomous vehicle as the automatic deployment of a software update 502 in response to a critical security event could permit a vehicle to maintain their autonomous function while mitigating an attack.

At operation 604, a procedure to install the software update 502 is initiated. In an example responsive to occurrence of the trigger at operation 602, one or more software update 502 may be sent to the ECU 102, where the software update 502 indicates which placeholder instruction(s) 202 and placeholder code area(s) 204 to update, as well as the updated code to be included in each. In another example, one or more of software updates 502 may be sent to a different ECU 102 on the vehicle network to update that other ECU 102. In yet another example, the software update 502 may indicate to activate an already loaded update resident to the ECU 102 onto another ECU 102 of the vehicle as a preventative measure. In another example, another mechanism may be used to update the vehicle, such as an internal mechanism within the vehicle (e. g, a flash drive), or potentially a service call to a service location/dealership.

At operation 606, the software update 502 is loaded into a memory 106. In an example, the instructions from the OTA update, flash drive, or other mechanism may be applied to the placeholder code area(s) 204 of the one or more ECUs 102 to be updated.

At operation 608, the placeholder instruction(s) 202 are replaced as indicated in the update, e.g., as specified by the placeholder instruction update 506 of the software update 502. For example, the placeholder instruction 202 may be replaced with a JMP instruction to the block of code implementing the software update 502. Or, the placeholder instruction 202 may be replaced with a JMP instruction to a block of code implementing a remote procedure call to a remote ECU 102 implementing the software update 502.

At operation 610, the procedure for applying the software update 502 is completed. For example, the ECU 102 may be restarted, and/or the remote ECU 102-R may be restarted. After operation 610, the process 600 ends.

Variations on the disclosed techniques are possible. In one example, the placeholder instructions 202 the original code segment 108 may be extended to implement other unique security features. One such feature is randomly adding blocks of delay to thwart a timing attack. If the amount of delay inserted at these placeholder instructions 202 is varied across a fleet of vehicles (or other devices that are seemingly identical to an adversary), an attacker would have a challenging time trying to design a timing-based attack on one vehicle and then attacking another as the timing characteristics will vary.

Additionally, the placeholder instructions 202 may be inserted into the code to produce a pattern unique to the software application 112 of the ECU 102. For example, a pattern of placeholder instructions 202 may serve as a unique “barcode” or fingerprint for that software application 112. The barcode could act as an integrity check for the software application 112 of the ECU 102, permit validation of the software application 112 without requiring keys or cryptographic hardware, and a unique identifier to more closely associate a vehicle with its vehicle identification number (VIN). This may also allow for identification of whether a specific version of software was leaked and/or the leaker of the software version. In some cases, the pattern of placeholder instructions may be chosen to perform a dual function, both to act as placeholder instructions (i.e. do not modify the control flow of the program) and also to induce a specific power consumption change when the power consumption is measured externally. This can also act as a fingerprint that is measured externally with an external device.

In another variation, the locations of the placeholder instructions 202 may be identified by a tool stack that builds the software application 112. For example, the tool stack may analyze source code being compiled to identify locations where placeholder instructions 202 may be useful, such as calls to cryptographic functions, beginnings of functions, ends of functions, etc. Thus, the placeholder instructions 202 mechanism may become an automatic part of the build process.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for deploying a software update to an electronic control unit (ECU), comprising:
receiving a software update to update existing portions of a software application, the software update indicating a placeholder instruction update to a placeholder instruction of the software application and a placeholder code area update to a placeholder code area of the software application;
applying the placeholder code area update to the placeholder code area, the placeholder code area being a pre-allocated portion of a code segment of the software application outside of a code path that is reserved at compile time for future use;
applying the placeholder instruction update to the placeholder instruction, the placeholder instruction being an instruction in the code path that is predefined in the software application as built, to be modified and/or replaced with another instructions to call a section of code that is outside of the code path; and
executing the software application as modified, to apply the software update.

2. The method of claim 1, wherein the placeholder instruction update indicates a location of the placeholder instruction to update and the instructions to replace the placeholder instruction with.

3. The method of claim 1, wherein the placeholder code area update indicates which placeholder code area to update and the instructions to add to the placeholder code area.

4. The method of claim 1, wherein the placeholder code area update indicates that the placeholder code area is preloaded with instructions and does not require an update.

5. The method of claim 1, wherein the placeholder code area update includes a remote procedure call to a remote computing device that to be called as part of the code path as updated.

6. The method of claim 1, wherein the placeholder instruction includes a delay loop that is replaced by the software update to preserve timing after addition of the placeholder code area update.

7. The method of claim 6, wherein the timing of the delay loop is randomized across the ECU and other ECUs executing the software application.

8. The method of claim 1, wherein the software update implements a reduced alternative to update the existing portions of the software application, the reduced alternative eliminating a feature or returning with an error to remove a function of the software application.

9. The method of claim 1, wherein the software update implements a stricter alternative to update the existing portions of the software application, the stricter alternative enhancing an existing security check or adding a new security check to increase security of a function of the software application.

10. The method of claim 1, wherein the software update implements a diverse alternative to update the existing portions of the software application, the diverse alternative including an alternative version of a function of the software application that is functionally equivalent but constructed differently.

11. The method of claim 1, wherein the placeholder instructions are located at the entry and/or exit points of basic blocks of instructions of the software application, wherein the basic blocks of instructions are connected by edges that are changes in control flow of the instructions.

12. The method of claim 1, wherein the placeholder instructions are located to produce a pattern unique to the software application for identifying the software application.

13. The method of claim 1, wherein the placeholder instructions are chosen to include a power consumption pattern unique to the software application for identifying the software application.

14. A system for deploying a software update to an electronic control unit (ECU), comprising:
an ECU having a memory and a processor, wherein the ECU is configured to:
receive a software update to update existing portions of a software application, the software update indicating a placeholder instruction update to a placeholder instruction of the software application and a placeholder code area update to a placeholder code area of the software application;
apply the placeholder code area update to the placeholder code area, the placeholder code area being a pre-allocated portion of a code segment of the software application outside of a code path that is reserved at compile time for future use;
apply the placeholder instruction update to the placeholder instruction, the placeholder instruction being an instruction in the code path that is predefined in the software application as built, to be modified and/or replaced with another instructions to call a section of code that is outside of the code path; and
execute the software application as modified using the processor, to apply the software update.

15. The system of claim 14, wherein the placeholder instruction update indicates a location of the placeholder instruction to update and the instructions to replace the placeholder instruction with.

16. The system of claim 14, wherein the placeholder code area update indicates which placeholder code area to update and the instructions to add to the placeholder code area.

17. The system of claim 14, wherein the placeholder code area update indicates that the placeholder code area is preloaded with instructions and does not require an update.

18. The system of claim 14, wherein the placeholder code area update includes a remote procedure call to a remote computing device that to be called as part of the code path as updated.

19. The system of claim 14, wherein the placeholder instruction includes a delay loop that is replaced by the software update to preserve timing after addition of the placeholder code area update.

20. The system of claim 19, wherein the timing of the delay loop is randomized across the ECU and other ECUs executing the software application.

21. The system of claim 14, wherein the software update implements a reduced alternative to update the existing portions of the software application, the reduced alternative eliminating a feature or returning with an error to remove a function of the software application.

22. The system of claim 14, wherein the software update implements a stricter alternative to update the existing portions of the software application, the stricter alternative enhancing an existing security check or adding a new security check to increase security of a function of the software application.

23. The system of claim 14, wherein the software update implements a diverse alternative to update the existing portions of the software application, the diverse alternative including an alternative version of a function of the software application that is functionally equivalent but constructed differently.

24. The system of claim 14, wherein the placeholder instructions are located at the entry and/or exit points of basic blocks of instructions of the software application, wherein the basic blocks of instructions are connected by edges that are changes in control flow of the instructions.

25. The system of claim 14, wherein the placeholder instructions are located to produce a pattern unique to the software application for identifying the software application.

26. The system of claim 14, wherein the placeholder instructions are chosen to include a power consumption pattern unique to the software application for identifying the software application.

27. A non-transitory computer-readable medium comprising instructions that, when executed by an ECU having a processor and a memory, cause the ECU to perform operations including to:
receive a software update to update existing portions of a software application, the software update indicating a placeholder instruction update to a placeholder instruction of the software application and a placeholder code area update to a placeholder code area of the software application;
apply the placeholder code area update to the placeholder code area, the placeholder code area being a pre-allocated portion of a code segment of the software application outside of a code path that is reserved at compile time for future use;
apply the placeholder instruction update to the placeholder instruction, the placeholder instruction being an instruction in the code path that is predefined in the software application as built, to be modified and/or replaced with another instructions to call a section of code that is outside of the code path; and
execute the software application as modified using the processor, to apply the software update.
